(19) United States
(12) Patent Application Publication
(10) Pub. No.: US 2012/0241049 A1
(43) Pub. Date: Sep. 27, 2012

(54) ELECTRIC POWER TOOL

(75) Inventors: Kazuya KATO, Anjo-shi (JP); Takuji KIMURA, Anjo-shi (JP); Yasuhiro HAYASHI, Anjo-shi (JP); Jun OTA, Anjo-shi (JP)

(73) Assignee: MAKITA CORPORATION, ANJO-SHI (JP)

(21) Appl. No.: 13/423,831

(22) Filed: Mar. 19, 2012

(30) Foreign Application Priority Data
Mar. 22, 2011 (JP) 2011-062262

(51) Int. Cl. B27C 5/10

(52) U.S. Cl. 144/136.95

(57) ABSTRACT

In an electric power tool, a controller, a capacitor, a terminal stand, a speed change controller, and a switch are arranged at positions offset from the axis of a spindle so as not to overlap the spindle as seen in a direction corresponding to the direction in which the spindle axially extends. The controller, the capacitor, the terminal stand, the speed change controller, and the switch are located so as to overlap a part of a drive motor as seen in a direction orthogonal to the direction in which the spindle axially extends. The controller, the capacitor, the terminal stand, the speed change controller, and the switch are located so as to overlap at least a part of a field as seen in a direction corresponding to the direction in which the spindle axially extends.

This application claims priority to Japanese patent application serial number 2011-062262, the contents of which are incorporated herein by reference.

### BACKGROUND OF THE INVENTION

1. Field of the Invention

The present invention relates to an electric power tool configured to perform machining such as edging or grooving a workpiece such as wood.

2. Description of the Related Art

Conventionally, there is known an electric power tool generally called a trimmer or a router, which performs machining such as edging or grooving a workpiece such as wood. Such an electric power tool is provided with a base and a tool main body also referred to as a motor unit. The base can be brought into contact with the workpiece by, for example, being placed thereon. In contrast, the tool main body is supported by the base, with its relative position with respect to the base being determined. The tool main body, whose relative position with respect to the base is determined, is also determined in relative position with respect to the workpiece held in contact with the base. The tool main body whose relative position with respect to the workpiece has been determined rotates a spindle by an internal drive motor, and performs machining the workpiece by a bit attached to the spindle. The tool main body is arranged such that the spindle extends vertically with respect to the workpiece that has a horizontal surface. In the tool main body thus arranged, the lower end side in the axial direction of the spindle is set to be a workpiece facing side of the tool main body facing the workpiece. In contrast, in the tool main body thus arranged, the upper end side of the spindle in the axial direction is set to be a head side of the tool main body on the opposite side of the workpiece facing side.

Regarding an electric power supplied to the drive motor mentioned above, there is provided a controller for adjusting the electric power such that a detected RPM (revolutions per minute) of the drive motor becomes equal to a predetermined reference RPM (See, for example, Japanese Patent Application Laid-Open No. 11-164579). This controller is arranged inside the head of a tool main body on the upper side of the drive motor.

Further, the above-described tool main body includes an air blower fan for cooling the internal components such as the drive motor and the controller etc. This air blower fan is attached to the spindle so as to rotate together with the spindle. The airflow generated by this air blower fan helps take outside air from the above-mentioned workpiece facing side into the tool main body, and emit the air to the outside after passing it through the tool main body. Due to the airflow generated by this air blower fan, it is possible to cool the inside components such as the drive motor and controller etc.

The above-mentioned tool main body is used so as to slide on the workpiece while placed on the workpiece. Thus, in order that the position of the center of gravity of the tool main body may be as close as possible to the workpiece facing side, it is desirable for the height of the head of the tool main body to be low.

As discussed, however, in Japanese Patent Application Laid-Open No. 11-164579, simply designing to lower the position of the head of the tool main body results in the controller being arranged so as to be placed on the upper end of the spindle. Then, the airflow generated by the above-mentioned air blower fan would be blocked, resulting in deterioration of efficiency in cooling of the drive motor, controller, etc.

### SUMMARY OF THE INVENTION

Thus, there is a need in the art to provide an electric power tool for performing machining such as edging or grooving a workpiece such as wood, wherein the construction and arrangement inside the tool main body is made more compact such that the height of the head of the tool main body can be lowered while the airflow caused by the air blower fan is maintained.

One construction for an electric power tool for performing machining such as edging or grooving the workpiece such as wood, can include a tool main body containing a drive motor for rotating a spindle, wherein a controller for adjusting an electric power supplied to the drive motor is arranged on a head side of the tool main body, which is on the opposite side of the workpiece facing side of the tool main body, and wherein the controller is located so as to overlap at least a portion of the drive motor as seen in a direction orthogonal to the direction in which the spindle of the drive motor extends.

In the electric power tool according to this construction, the controller is located so as to overlap at least a portion of the drive motor as seen in a direction orthogonal to the direction in which the spindle of the drive motor extends, and thus the protrusion part of the drive motor and the protrusion part of the controller can be overlapped in the direction in which the spindle extends. As a result, it is possible to reduce the bulk of the head of the tool main body, and a more compact design can be achieved.

Thus, in an electric power tool for performing machining such as edging or grooving the workpiece such as wood, an arrangement of components inside the head of the tool main body can be compact and the height of the tool main body can be lowered while the airflow caused by the air blower fan is maintained.

According to another construction, there is provided an electric power tool in which the controller is located to be offset from the axis of the spindle so as not to overlap the spindle as seen in a direction corresponding to the direction in which the spindle of the motor extends.

In the electric power tool according to this construction, the controller is located to be offset from the axis of the spindle so as not to overlap the spindle as seen in a direction corresponding to the direction in which the spindle of the motor extends, and thus it is possible to pass the air through the tool body along the spindle. As a result, the cooling efficiency inside the tool main body can be improved. Further, there is no need to increase a volume of the head of the tool main body in order to obtain a passage for the airflow, and an arrangement of components inside the head of the tool main body can be compact and the height of the head of the tool main body can be lowered. In this way, an arrangement of components inside the head of the tool main body can be compact and a cooling efficiency inside the tool main body can be improved.

According to another construction, there is provided an electric power tool in which the drive motor is provided with a stator that corresponds to a rotor configured to rotate together with the spindle, and the controller is located so as to overlap at least a portion of the stator as seen in a direction corresponding to the direction in which the spindle of the drive motor extends.

The direction orthogonal to the direction in which the spindle extends corresponds to a radial direction of the spindle in rotation.

In the electric power tool according to this construction, the controller is located so as to overlap at least a portion of the stator as seen in a direction corresponding to the direction in which the spindle of the drive motor extends, and thus the protrusion part of the stator and the protrusion part of the controller can be overlapped in the radial direction of the spindle in rotation. As a result, it is possible to reduce the bulk of the head of the tool main body and a more compact design can be achieved.

According to another construction, there is provided an electric power tool in which the controller is arranged such that the surface of the most extensive plane of the configuration thereof extends in the direction in which the spindle of the drive motor extends.

In the electric power tool according to this construction, the controller is arranged such that the surface of the most extensive plane of the configuration thereof extends in the direction in which the spindle of the drive motor extends, and thus the spindle and the protrusion part of the most extensive plane of the configuration of the controller can be overlapped in the length direction of the spindle. As a result, it is possible to reduce the bulk of the head of the tool main body, and a more compact design can be achieved

According to another construction, there is provided an electric power tool in which at least two electrical components including the controller that are related to the driving of the drive motor are provided, and the two electrical components are located symmetrically at 180 degrees to each other around the position at which the spindle of the drive motor extends.

In the electric power tool according to this construction, the two electrical components are arranged symmetrically at 180 degrees to each other around the position at which the spindle of the drive motor extends, and thus the arrangement space for the two electrical components can be easily and efficiently obtained. As a result, the protrusion parts of these two electrical components can be arranged in the arrangement space, and it is possible to reduce the bulk of the head of the tool main body, and a more compact design can be achieved.

According to another construction, there is provided an electric power tool in which at least three electrical components including the controller that are related to the driving of the drive motor are provided, and the three electrical components are arranged at right angles to each other around the position at which the spindle of the drive motor extends.

In the electric power tool according to this construction, the three electrical components are arranged at right angles to each other around the position at which the spindle of the drive motor extends, and thus the arrangement space for the three electrical components can be easily and efficiently obtained. As a result, the protrusion parts of these three electrical components can be arranged in the arrangement space, and it is possible to reduce the bulk of the head of the tool main body, and a more compact design can be achieved.

According to another construction, there is provided an electric power tool in which at least four electrical components including the controller that are related to the driving of the drive motor are provided, and the four electrical components are arranged at right angles to each other around the position at which the spindle of the drive motor extends.

In the electric power tool according to this construction, the four electrical components are arranged at right angles to each other around the position at which the spindle of the drive motor extends, and thus the arrangement space for the three electrical components can be easily and efficiently obtained. As a result, the protrusion parts of these four electrical components can be arranged in the arrangement space, and it is possible to reduce the bulk of the head of the tool main body, and a more compact design can be achieved.

According to another construction, there is provided an electric power tool in which there is provided a power cord that is pulled out from the inside of the tool main body to the outside of the tool main body and connected to an external power source in order to supply power to the drive motor, and the location from which the power cord is pulled out is located in the upper side of the tool main body in the direction toward the workpiece facing side of the tool main body with respect to the end portion of the drive motor, and the direction from which the power cord is pulled out is orthogonal to the direction in which the spindle of the drive motor extends.

The direction in which the tool main body extends between the workpiece facing side and the head side of the tool main body corresponds to the direction in which the spindle of the drive motor extends.

In the electric tool according to this construction, the location from which the power cord is pulled out is located on the head side of the tool main body, and also in the workpiece facing side of the tool main body with respect to the end portion of the drive motor that faces toward the head side of the tool main body, and thus the position of the power cord can be located on the workpiece facing side of the end portion of the head side of the tool main body in which the drive motor is accommodated. The end portion of the head side of the tool main body is the end portion of the head that faces the opposite side of the workpiece facing side of the tool main body. Further, the direction from which the power cord is pulled out is orthogonal to the direction in which the spindle of the drive motor axially extends, and thus, there is no possibility that the direction from which the power cord is pulled out does not correspond to the direction toward the end portion of the head of the tool main body.

As a result, in the electric power tool described above, the end portion of the head of the tool main body is formed as the placing portion that allows the tool to put upside down, and thus, in the case where the tool main body is put upside down, there is no possibility that the power cord is caught between the placing portion and the workpiece. Accordingly, even when the tool main body is put upside down, it can be placed in a stable manner without the power cord being interfered with the tool main body. Thus, the usability of the tool main body can be improved.

In the electric power tool according to one construction, an arrangement of components inside the head of the tool main body can be compact and the height of the tool main body can be lowered while the airflow caused by the air blower fan is maintained.

In the electric power tool according to another construction, an arrangement of components inside the head of the tool main body can be compact and a cooling efficiency inside the tool main body can be improved.

In the electric power tool according to another construction, a protrusion part of the controller and a protrusion part of the stator can be overlapped, and thus the tool main body can be more compact.

In the electric power tool according to another construction, the spindle and a protrusion part of the most extensive plane of the controller can be overlapped, and thus the tool main body can be more compact.

In the electric power tool according to another construction, protrusion parts of two electrical components can be arranged in an arrangement space that is efficiently obtained, and thus the head of the tool main body can be more compact.

In the electric power tool according to another construction, protrusion parts of three electrical components can be arranged in an arrangement space that is efficiently obtained, and thus the head of the tool main body can be more compact.

In the electric power tool according to another construction, protrusion parts of four electrical components can be arranged in an arrangement space that is efficiently obtained, and thus the head of the tool main body can be more compact.

In the electric power tool according to another construction, usability of the tool main body can be improved,

### BRIEF DESCRIPTION OF THE DRAWINGS

FIG. 1 is a perspective view of an electric power tool, showing a tool main body and a base that are spaced apart from each other;

FIG. 2 is a front view of the electric power tool, showing the tool main body is attached to the base;

FIG. 3 is a cross-sectional view taken from line III-III of FIG. 1;

FIG. 4 is a cross-sectional view taken from line IV-IV of FIG. 1;

FIG. 5 is a cross-sectional view taken from line V-V of FIG. 1;

FIG. 6 is a sectional view of the tool main body of FIG. 3 when the head housing, etc. are removed; and

FIG. 7 is a sectional view of the tool main body of FIG. 5 when the head housing, etc. are removed.

### DETAILED DESCRIPTION OF THE INVENTION

Each of the additional features and teachings disclosed above and below may be utilized separately or in conjunction with other features and teachings to provide an improved electric power tool. Representative examples of the present teaching, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings.

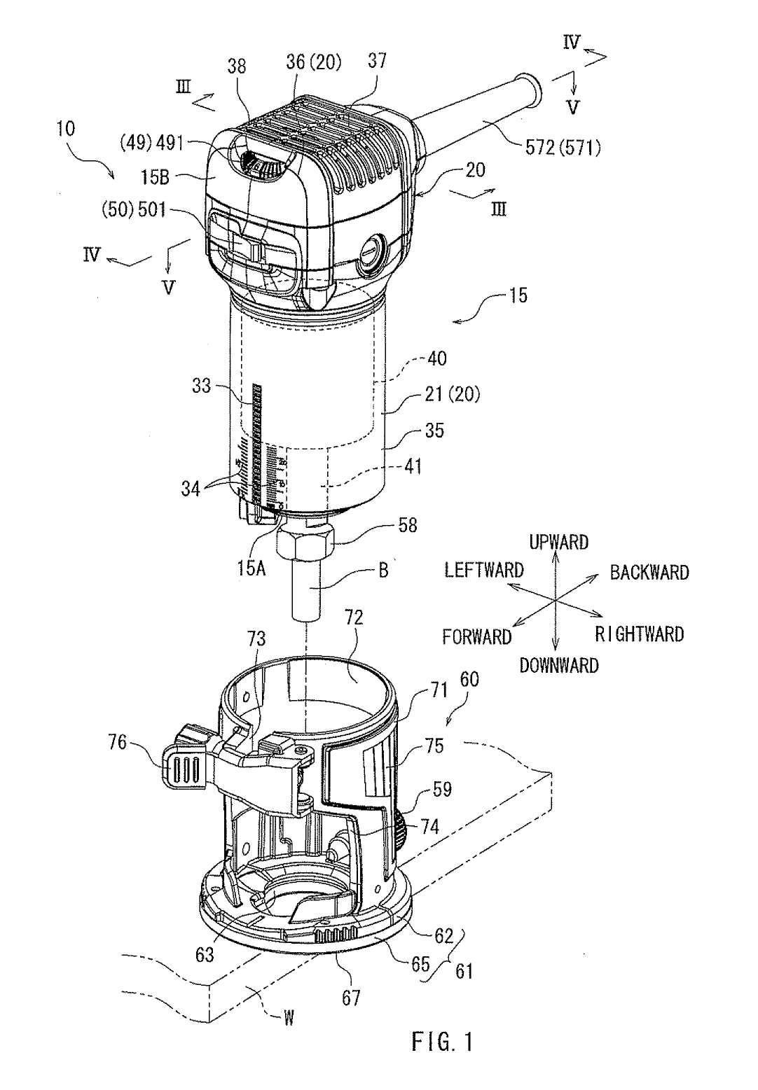

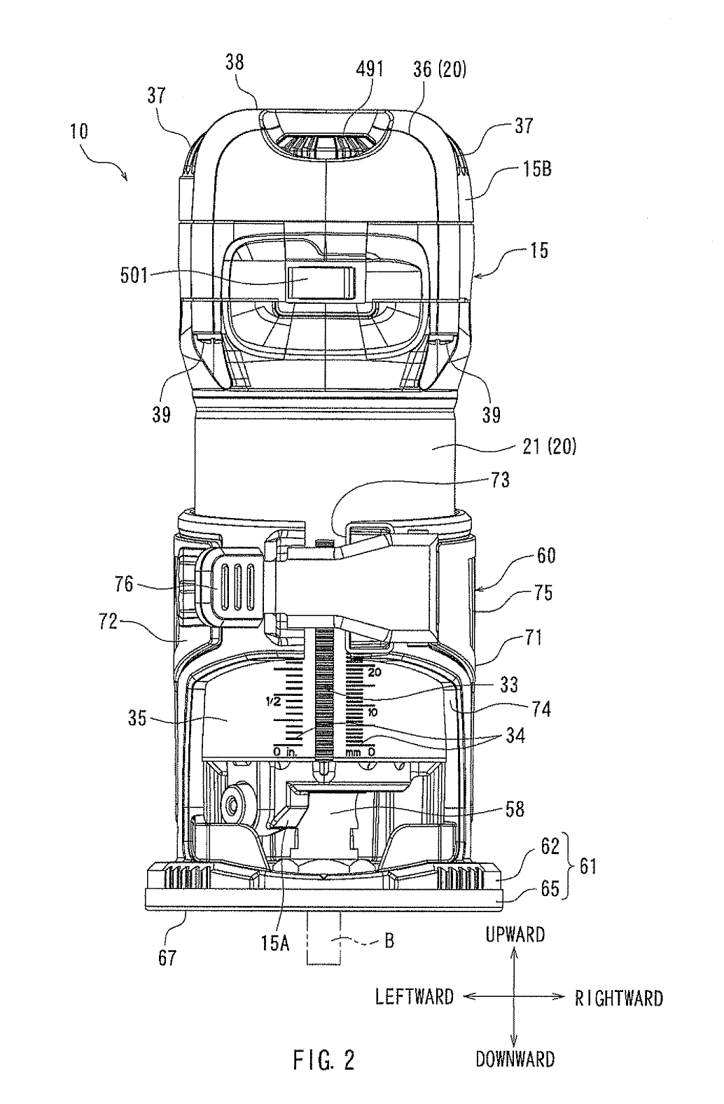

In the following, an electric power tool according to an embodiment of the present invention will be described with reference to the drawings. FIG. 1 is a perspective view of an electric power tool 10, showing a tool main body 15 and a base 60 that are spaced apart from each other. FIG. 2 is a front view of the electric power tool 10 with the tool main body 15 being attached to the base 60. In the following, the upper (upward), lower (downward), front (forward), rear (backward), right (rightward), and left (leftward) sides as referred to in the direction are the same as those described in the drawings so that the description can be understood easily and correctly.

An electric power tool 10 shown in FIG. 1 is widely used as a trimmer, and is configured to perform machining such as edging or grooving a workpiece W such as wood. Roughly speaking, the electric power tool 10 is provided with a tool main body 15 configured to perform machining the workpiece W, and a base 60 that supports the tool main body 15. As described in detail later, the tool main body 15 includes a drive motor 40 for generating a rotational drive force for performing machining on the workpiece W. The drive motor 40 corresponds to a rotation drive mechanism in the present invention. The drive motor 40 rotates a spindle 41. At the distal end of the spindle 41, a chuck mechanism 58 is provided to attach a bit B as a cutter. The chuck mechanism 58 is called a collet cone, and is configured to hold the bit B. While thus holding the bit, the tool main body 15 performs machining by rotating the bit B of the spindle 41. In the tool main body 15, the side thereof facing the workpiece W is referred to as the workpiece facing side 15A (the lower portion of the tool main body 15 as seen in the drawing) of the tool main body 15. Further, in the tool main body 15, the portion on the opposite side of the workpiece facing side 15A is referred to as the head side 15B (the upper portion of the tool main body 15 as seen in the drawing) of the tool main body 15. The head side 15B of the tool main body 15 described below is also formed as the head of the tool main body 15. The internal structure of the tool main body 15 will be described after the description of the base 60.

The base 60 has a workpiece abutment surface 67 to be brought into contact with the workpiece W, and is configured to support the tool main body 15, with the relative position of the tool main body 15 with respect to the workpiece W being determined. Roughly speaking, the base 60 is provided with a base main body 61 to be held in contact with the workpiece W, and a grip structure portion 71 provided integrally with the base main body 61. The base main body 61 is formed such that the bit B of the tool main body 15 can protrude downwardly from the workpiece abutment surface 67 constituting the lower surface of the base 60. The base main body 61 is provided with a flange portion 62 and a base attachment 65. The flange portion 62 has at its central portion a protrusion hole 63 extending vertically therethrough. From this protrusion hole 63, the bit B of the tool main body 15 can protrude downwardly from the workpiece abutment surface 67 located under the face flange portion 62. The flange portion 67 is formed as a flange protruding horizontally. The base attachment 65 is attached to the lower side of the flange portion 62 by screws. The grip structure portion 71 extending cylindrically upwards is provided on the upper surface side of the face flange portion 62. The base attachment 65 is formed in the same configuration as the flange portion 62, and is detachable with respect to the flange portion 62. The lower surface of the base attachment 65 attached to the flange portion 62 is formed as the workpiece abutment surface 67 held in contact with the workpiece W. Reference numeral 59 indicates a fastening member for attaching a parallel ruler.

The grip structure portion 71 is provided with a C-shaped cylindrical portion 72 integrated with the flange portion 62, and a clamp device 76 arranged on the front side of the C-shaped cylindrical portion 72. The C-shaped cylindrical portion 72 has a slit 73 on the front side so as to be C-shaped as seen from above. The slit width of the slit 73 is increased or decreased by clamping the clamp device 76 described below. By increasing or decreasing the slit width of this slit 73, the inner diameter of the C-shaped cylindrical portion 72 increases or decreases. That is, in the case where the inner diameter of the C-shaped cylindrical portion 72 decreases, the C-shaped cylindrical portion 72 can hold a grip outer peripheral surface 35 of the tool main body 15. To the contrary, in the case where the inner diameter of the C-shaped cylindrical portion 72 increases, the C-shaped cylindrical portion 72 can loosen with respect to the grip outer peripheral surface 35 of the tool main body 15, and the C-shaped cylindrical portion 72 can slide relative to the grip outer peripheral surface 35 of the tool main body 15.

A window portion 74 is formed under the slit 73 of the C-shaped cylindrical portion 72. This window portion 74 is formed such that a protrusion hole 63 through which the bit B can protrude can be seen from outside. On a part of the outer side peripheral surface of the C-shaped cylindrical portion 72, there is arranged elastomer that covers the outer side peripheral surface of the C-shaped cylindrical portion 72 as a hand-grip portion 75. This elastomer constituting the hand-grip portion 75 has a knurled external configuration of an appropriate interval. Thus, due to the knurled external configuration of an appropriate interval and the elasticity of the elastomer, this hand-grip portion 75 is easy to grasp by hand.

The clamp device 76 is arranged so as to stride over the slit 73 that is located on the front side of the C-shaped cylindrical portion 72. Although not shown in detail, roughly speaking, this clamp device 76 is provided with a lever mechanism that can increases and decreases the slit width of the slit 73, and also provided with a dial mechanism configured to raise and lower the tool main body 15 with respect to the base 60. This clamp device 76 is provided with an operation rod that is used both by the lever mechanism and the dial mechanism. In this way, after a relative position of the tool main body 15 with respect to the workpiece W has been appropriately determined by use of the dial mechanism, the clamp device 76 holds the grip outer peripheral surface 35 with the C-shaped cylindrical portion 72 by use of the lever mechanism to thereby support the tool main body 15.

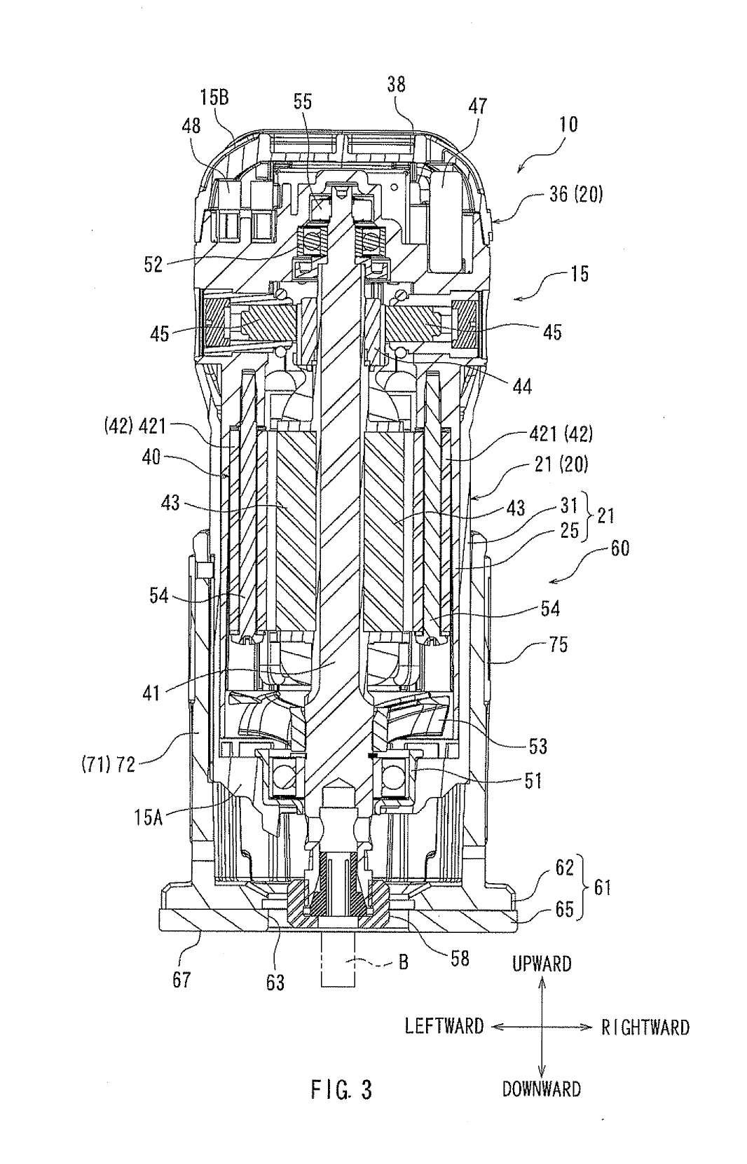

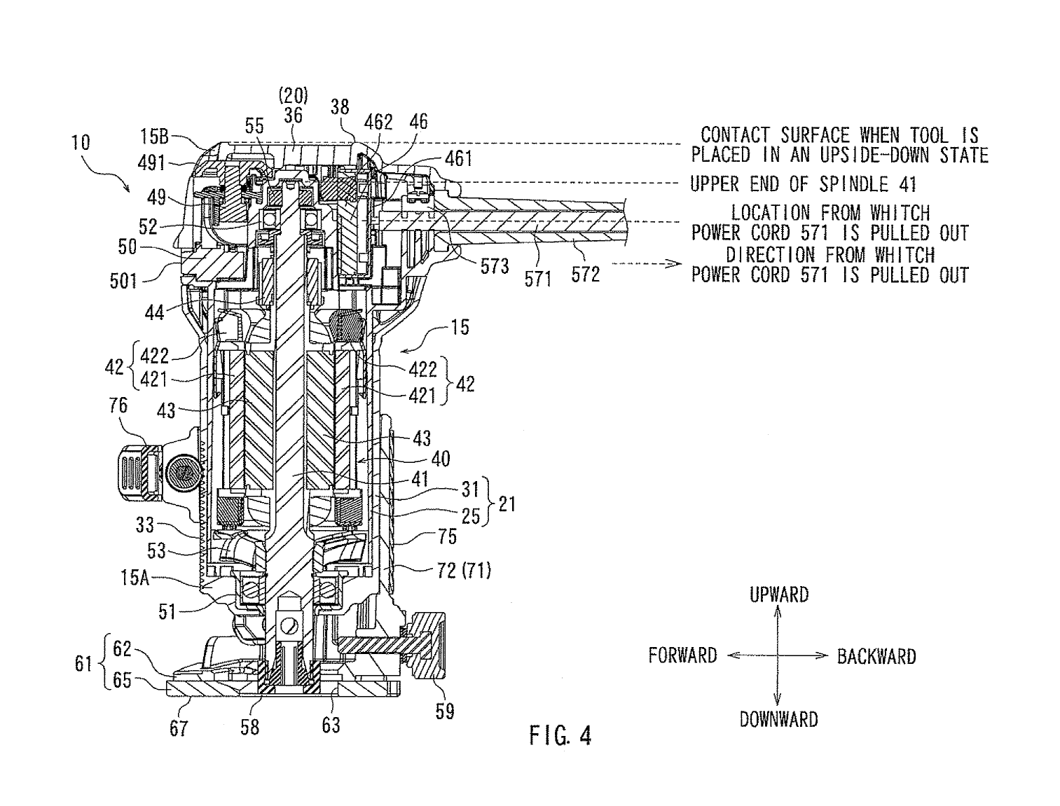

Next, the internal structure of the tool main body 15 will be described. FIGS. 3 and 4 are sectional views of the tool main body 15 attached to the base 60. More specifically, FIG. 3 is a cross-sectional view of the electric power tool 10 taken from line of FIG. 1. FIG. 4 is a cross-sectional view of the electric power tool 10 taken from line IV-IV of FIG. 1.

As shown in FIGS. 3 and 4, the tool main body 15 is provided with a housing 20. This housing 20 has an outside portion of the tool main body 15 and functions as a casing in which a drive motor 40 etc. are accommodated. This housing 20 is formed by integrating a motor housing 21 located on the lower side as seen in the drawing, which is the workpiece W side, and a head housing 36 located on the upper side as seen in the drawing.

As shown in FIG. 2, the motor housing 21 and the head housing 36 are attached through vertical threaded engagement by screw members 39. In the following, devices such as the drive motor 40 that are accommodated in the housing 20 will be described.

The tool main body 15 includes the following devices. As shown in FIGS. 3 and 4, in the intermediate portion of the tool main body 15 formed substantially in a columnar configuration, there is provided the drive motor 40 such that a spindle 41 extends vertically. The drive motor 40 corresponds to a rotation drive mechanism according to the present invention, and is a bush motor that is widely in use. The drive motor 40 rotates the spindle 41 as a drive shaft. The spindle 41 is arranged inside the tool main body 15 so as to extend in the length direction of the tool main body 15. The lower end of the spindle 41 protrudes from the lower end side within the motor housing 21 on the workpiece W side. In contrast, the upper end of the spindle 41 is located near the upper end within the head housing 36. As a result, the lower end side of the spindle 41 is rotatably supported by a lower-side ball bearing 51 arranged at the lower end side within the motor housing 21. The upper end side of the spindle 41 is rotatably supported by an upper-side ball bearing 52 arranged at the upper end side within the head housing 36. Further, on the upper side of the upper side ball bearing 52, there is arranged a magnet sleeve 55. This magnet sleeve 55 is a detector for detecting the RPM of the spindle 41, and is configured to transmit the detected RPM of the spindle 41 to a controller 46 described below.

As stated above, this drive motor 40 is a brush motor, and is provided with a field 42 as a stator, an armature 43 as a rotor, a commutator 44, and a carbon brush 45. As described in detail later, the field 42 and the armature 43 are arranged inside the motor housing 21 of the housing 20. On the other hand, the commutator 44 and the carbon brush 45 are arranged inside the head housing 36 of the housing 20.

The field 42 is fixedly supported with respect to the motor housing 21. The armature 43 and the commutator 44 are fixedly supported with respect to the spindle 41 that is rotatably supported. The commutator 44 can supply electrical power to the armature 43 through electrical contact with the carbon brush 45. The armature 43 to which electric power has been supplied generates a magnetic field, and the armature 43 rotates relative to the field 42, and the spindle 41 that is fixed to support this armature 43 rotates.

The field 42 is formed by winding an electric wire around a core. This field 42 is provided with a field main body 421 facing the armature 43, and a winding portion 422 wound so as to be stuck out of the field main body 421. The field main body 421 is arranged so as to face the armature 43. The vertical length of the field main body 421 is the same as that of the armature 43. The field 42 is fastened to an inner housing 25 described later by a screw member 54.

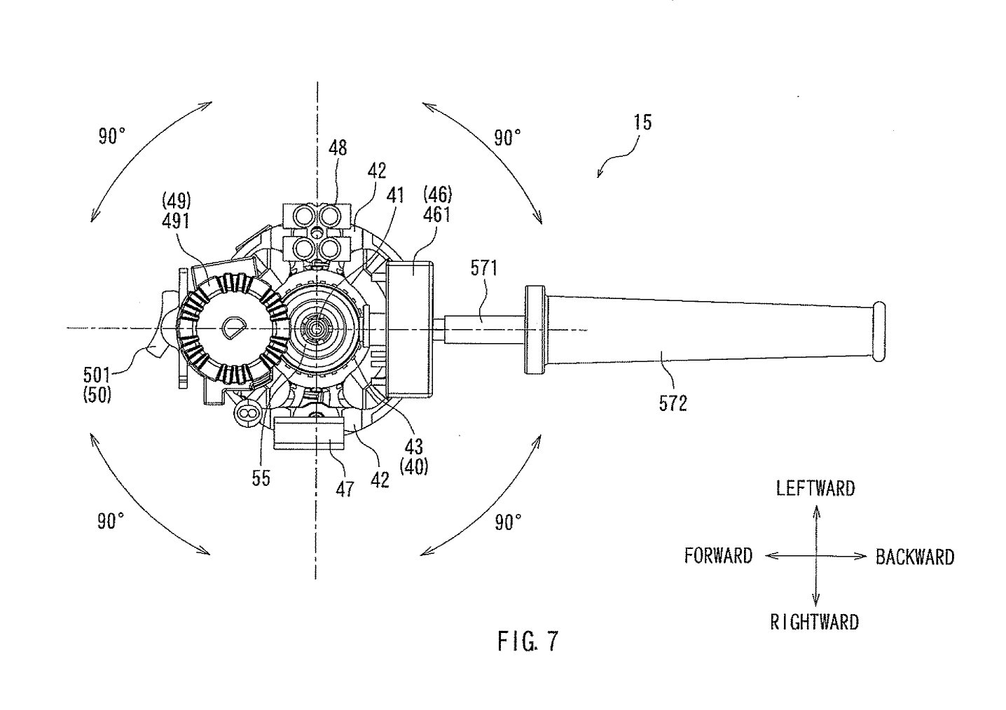

On the upper side of the commutator 44 and the carbon brush 45, there are arranged electrical components such as a controller 46, a capacitor 47, a terminal stand 48, and a speed change controller 49. These electrical components such as the controller 46, the capacitor 47, the terminal stand 48, and the speed change controller 49 are electrical components related to the driving of the drive motor 40. Further, near the commutator 44 and the carbon brush 45, there is provided a switch 50 for turning on/off the power source of this tool main body 15. This switch 50 is also an electrical component related to the driving of the drive motor 40. In this way, in the tool main body 15, there are arranged the five components, that is, the controller 46, the capacitor 47, the terminal stand 48, the speed change controller 49, and the switch 50, as the electrical components related to the driving of the drive motor 40. Further, as shown in FIGS. 4 and 7, the controller 46 is provided with a housing case 461 that is formed as a substantially rectangular solid. Inside this housing case 461, there is provided a control board 462.

The above-mentioned speed change controller 49 allows an operational input from a speed change operation dial 491 that is arranged outside of the housing, and the operating speed of the spindle 41 can be set in response to this operational input. Further, the switch 50 allows an operational input from an on/off operating portion 501 that is arranged outside of the housing, and the tool main body 15 can be turned on and off in response to this operational input.

Between the lower side ball bearing 51 and the field 42, there is provided an air blower fan 53. And, this air blower fan 53 is fixed to the above-mentioned spindle 41. As a result, the air blower fan 53 rotates in response to the rotation of the spindle 41, sending air upwardly from below to within the housing 20. The upper end portion of the tool main body 15, in which the various electrical components are arranged, is covered with a head housing 36. The upper surface of the head housing 36 is formed as a placing portion 38. In order that the tool main body 15 can be put upside down, the placing portion 38 is formed to be flat. Further, this head housing 36 is provided with a ventilation hole 37 that is formed as a slit through which air can be emitted into the outside of the housing 20. That is, the air blower fan 53 incorporated in the tool main body 15 rotates as the spindle 41 rotates, and the rotating air blower fan 53 takes in outside air into the tool main body 15 from the workpiece facing side 15A of the tool main body 15 (the lower portion of the tool main body 15 as seen in the drawing), causing the air to flow in the axial direction of the spindle 41. And then, after passing through the tool main body 15, the air is emitted from the head side 15B (the upper portion of the tool main body 15 as seen in the drawing) to the outside of the tool main body 15 via a ventilation hole 37. Due to the airflow thus generated by the air blower fan 53, the internal components such as the drive motor 40 and the controller 46 are cooled down.

Next, the housing 20 incorporating the above-mentioned internal devices will be explained. As described above, this housing 20 is formed by attaching the motor housing 21 to the head housing 36 with each other.

First, the motor housing 21 will be explained. The motor housing 21 incorporates the field 42 and the armature 43 of the drive motor 40, and on the outside of the motor housing 21, a grip outer peripheral surface 35 is formed that can be held by the base 60. This motor housing 21 has an inner housing 25 and an outer housing 31, which is referred to as a double housing structure. That is, in the motor housing 21, the cylinder of the outer housing 31 covers the inner housing 25, and thus, the motor housing 21 is of a double structure seen in sectional view, and the inner housing 25 and the outer housing 31 are adjacent to each other in the radial direction.

The inner housing 25 constitutes the inner side of the motor housing 21 so as to face the drive motor 40. This inner housing 25 is formed by molding resin such as so-called synthetic resin. The resin such as synthetic resin of which the inner housing 25 is made has a feature to insulate electrical conduction and heat conduction.

As also shown in FIG. 4, etc., the lower end side of the inner housing 25 extends to the portion where the air blower fan 53 is arranged, and the upper end side thereof extends to the portion where the commutator 44 is arranged. Further, the upper portion of the inner housing 25 around the commutator 44 is of a somewhat complicated configuration. In contrast, the portion of the inner housing 25 on the lower side of the commutator 44 is substantially formed as a bottomed cylinder, with the diameter thereof being almost the same as that of the portion around the commutator 44.

The outer housing 31 constitutes the outer side of the motor housing 21 so as to face the base 60. The outer housing 31 is formed of metal such as aluminum. As shown in FIG. 4, the lower end side of the outer housing 31 extends to the portion where the lower ball bearing 51 is arranged, and the upper end side thereof extends to the portion where the commutator 44 is arranged. Regarding the configuration of the outer housing 31 on the lower side of the commutator 44, it is formed substantially as a bottomed cylinder, with the diameter thereof being almost the same as the portion around the lower bearing 51. In contrast, regarding the configuration of the outer housing 31 around the commutator 44 near the upper end thereof, it is formed such that the diameter of this substantially bottomed-cylinder-like configuration enlarges.

On the outer side surface of the outer housing 31, there is provided the grip outer peripheral surface 35 with a uniform diameter. As described above, the grip outer peripheral surface 35 can be held by a face contact with the inner peripheral surface of the C-shaped cylindrical portion 72 of the base 60. Further, the grip outer peripheral surface 35 is configured to smoothly slide when inserted into the C-shaped cylindrical portion 72. More specifically, the grip outer peripheral surface 35 is formed by performing machining (cutting), and thus, this grip outer peripheral surface 35 can be manufactured with high dimensional accuracy and formed in a vertically straight configuration.

This grip outer peripheral surface 35 extends to the position of the field 42 which the upper end thereof on the opposite side of the workpiece W covers. More specifically, as shown in FIG. 4, the grip outer peripheral surface 35 is configured such that the upper end position of this grip outer peripheral surface 35 is located on the lower side of the upper end position of the field 42. In the case where the tool main body 15 is held by the C-shaped cylindrical portion 72 of the base 60, with the tool main body 15 being closest to the workpiece W side (with the tool main body 15 being located at the lowermost position), the upper end position of the C-shaped cylindrical portion 72 of the base 60 will be located on the lower side of the upper end position of the grip outer peripheral surface 35. Thus, the grip outer peripheral surface 35 held by the C-shaped cylindrical portion 72 with the tool main body 15 being closest to the workpiece W side (with the tool main body 15 being located at the lowermost position) corresponds to the portion where the field 42 is located.

A rack 33 is provided on the front side of the grip outer peripheral surface 35 so as to extend in the insertion direction of the tool main body 15 (the vertical direction in the drawing) to the base 60. The rack 33 is formed so as to engage with the gear of the dial mechanism for raising and lowering the tool main body 15 with respect to the base 60. By the side of and adjacent to the rack 33, there is provided an indicator scale 34 for indicating the relative position of the tool main body 15 with respect to the base 60.

Next, the functions and mutual arrangement of the five electrical components, the controller 46, the capacitor 47, the terminal stand 48, the speed change controller 49, and the switch 50 that are related to the driving of the drive motor 40 will be explained.

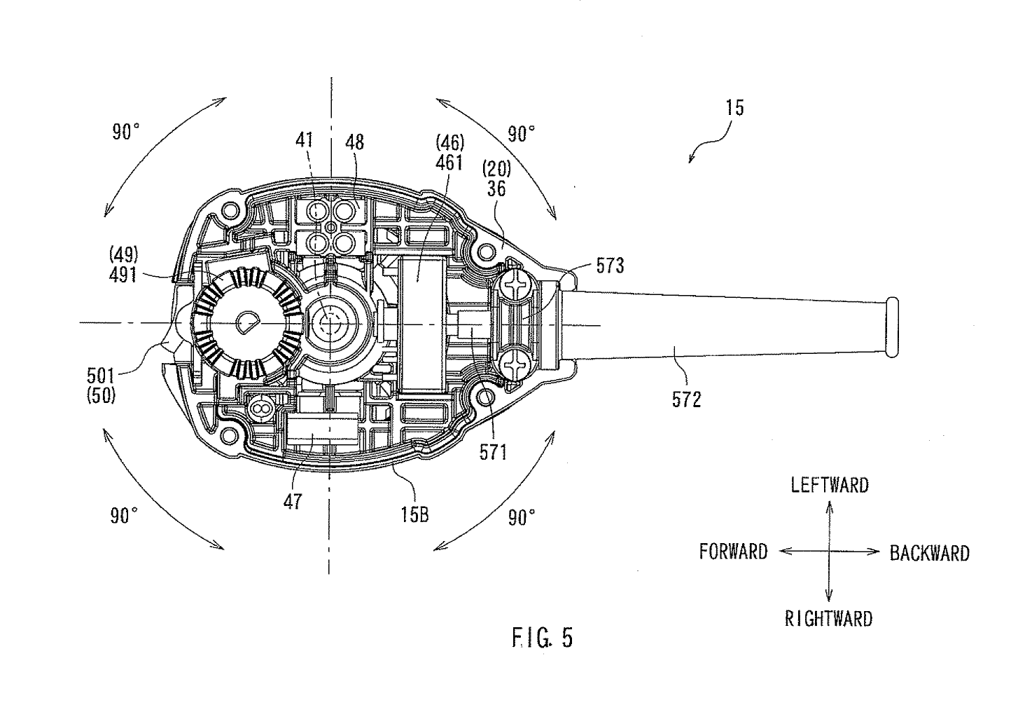

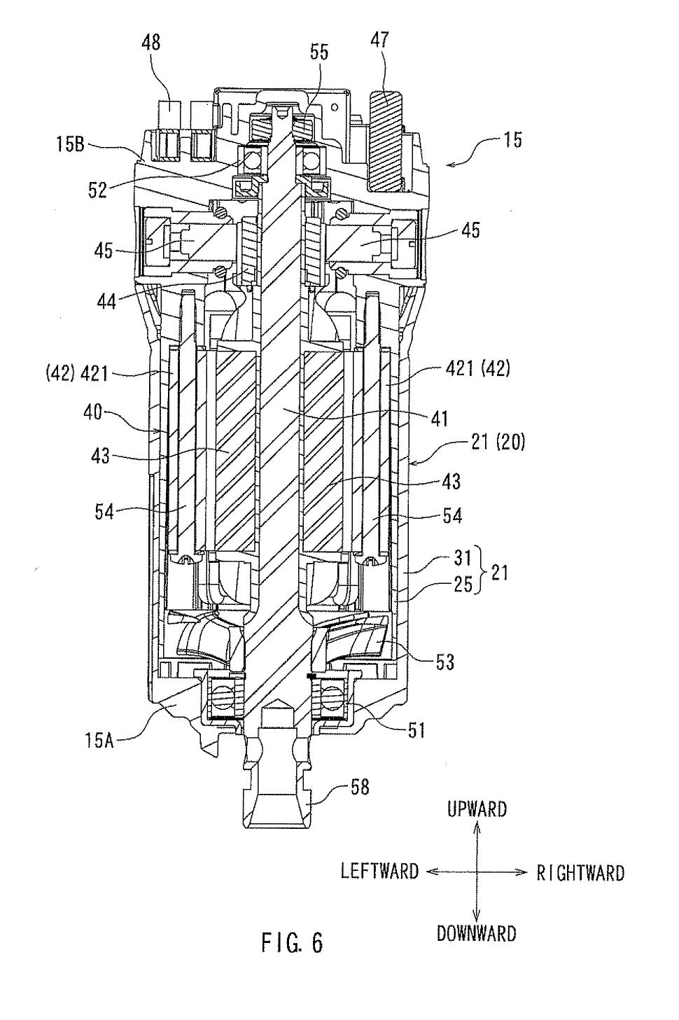

FIG. 5 is a cross-sectional view of the tool main body 15 taken from line V-V of FIG. 1. FIG. 6, as with FIG. 3, is a cross-sectional view of the same, showing a condition where the head housing 36 is removed. FIG. 7 is, as with FIG. 5, a cross-sectional view, showing a condition where the head housing 36 is removed.

FIGS. 3, 4, and 6 are views seen in a direction orthogonal to the direction in which the spindle 41 of the drive motor 40 extends. In contrast, FIGS. 5 and 7 are views seen in a direction corresponding to the direction in which the spindle 41 of the drive motor 40 extends. The direction orthogonal to the axial direction of the spindle 41 is a direction corresponding to a radial direction of the spindle 41 in rotation.

First, the functions of the electrical components will be described.

The controller 46 has a function to adjust electric power to be supplied so that the drive motor 40 can rotate at a fixed rotational speed. The RPM of the spindle 41 is supplied to the controller 46 from the above-mentioned magnet sleeve 55. Based on the RPM of the spindle 41 supplied from the magnet sleeve 55, the controller 46 calculates a rotating speed of the spindle 41. The calculated rotating speed of the spindle 41 is then compared with a predetermined rotating speed of the spindle 41 set by the speed change controller 49 described below. The controller 46 adjusts the electric power supplied to the drive motor 40 such that the actual rotating speed of the spindle 41 becomes closer to the predetermined rotating speed of the spindle 41. In this way, an actual rotating speed of spindle 41 maintains at a fixed speed by the controller 46. Furthermore, the electric power supplied to the drive motor 40 is supplied from an external power source via the power cord 571.

The capacitor 47 has a function to smoothen the power voltage supplied to the drive motor 40. The terminal stand 48 functions as a terminal connecting the terminals in supplying power to the drive motor 40. The speed change controller 49 has a function to set a predetermined rotational speed of the controller 46 in response to an operational input to a speed change operation dial 491. The switch 50 has a function to turn on and off the power supply to the drive motor 40, etc. in accordance with an operational input to an ON/OFF operation portion 501.

Next, an arrangement of the above-mentioned electrical components will be explained.

As shown in FIGS. 3 and 4, the controller 46, the capacitor 47, the terminal stand 48, the speed change controller 49, and the switch 50 are arranged on the head side 15B of the tool main body 15 with respect to the drive motor 40. As shown in FIGS. 5 and 7, the controller 46, the capacitor 47, the terminal stand 48, the speed change controller 49, and the switch 50 are arranged so as to be offset from the axis of the spindle 41 so that they may not overlap the spindle 41 as seen in a direction corresponding to the direction in which the spindle 41 of the drive motor 40 extends. More specifically, the controller 46, the capacitor 47, the terminal stand 48, the speed change controller 49, and the switch 50 are located so as to be offset from the axis of the spindle 41 to the radial direction of the spindle 41 in rotation.

Further, as shown in FIG. 7, the controller 46, the capacitor 47, the terminal stand 48, the speed change controller 49, and the switch 50 are arranged so as to stride over the field 42 as seen in the direction corresponding to the axial direction of the spindle 41 of the drive motor 40. Thus, as shown in FIG. 7, the controller 46, the capacitor 47, the terminal stand 48, the speed change controller 49, and the switch 50 are located so as to overlap at least a part of the field as seen in the direction corresponding to the axial direction of the spindle 41 of the drive motor 40.

As shown in FIG. 4, the switch 50 is arranged so as to entirely overlap the spindle 41 of the drive motor 40 in the vertical direction as seen in a direction orthogonal to the direction in which the spindle 41 of the drive motor 40 axially extends. That is, the upper end portion of the switch 50 is located on the lower side of the upper end position of the spindle 41 of the drive motor 40. Further, as shown in FIG. 4, the speed change controller 49 is arranged on the upper side of the switch 50.

As shown in FIG. 4, the controller 46 and the speed change controller 49 are arranged such that a part on the lower side thereof overlaps the spindle 41 of the drive motor 40 in the vertical direction as seen in the direction orthogonal to the direction in which the spindle 41 of the drive motor 40 axially extends. That is, the lower end portions of the controller 46 and the speed change controller 49 are located on the lower side of the upper end position of the spindle 41 of the drive motor 40, and the upper end portions of the controller 46 and the speed change controller 49 are located on the upper side of the upper end position of the spindle 41 of the drive motor 40.

Further, as shown in FIGS. 4 and 7, regarding the configuration of the contour of the controller 46, it is formed substantially as a rectangular solid by the housing case 461. Thus, as shown in the drawings, the controller 46 is arranged such that the surface of the most extensive plane of the configuration of the controller 46 formed substantially as a rectangular solid faces the spindle 41 of the drive motor 40. In this way, the controller 46 is arranged such that the surface of the most extensive plane of the configuration of the controller 46 extends in the direction in which the spindle 41 of the drive motor 40 extends. The surface direction of the most extensive plane of the configuration of the controller 46 corresponds to the extension surface direction of a control board 462 provided inside the housing case 461.

As shown in FIGS. 3 and 6, the capacitor 47 and the terminal stand 48 are arranged so as to partly overlap the spindle 41 of the drive motor 40 in the vertical direction as seen in the direction orthogonal to the axial direction in which the spindle 41 of the drive motor 40 extends. That is, the lower end portions of the capacitor 47 and the terminal stand 48 are located on the lower side of the upper end position of the spindle 41 of the drive motor 40.

As shown in FIG. 7, the four electrical components, the controller 46, the capacitor 47, the terminal stand 48, and the speed change controller 49 are arranged at right angles to each other around the axis of the spindle 41. Further, the switch 50 is arranged on the lower side of the speed change controller 49, and thus in the combination of the controller 46, the capacitor 47, the terminal stand 48, and the switch 50, they are arranged at right angles to each other around the axis of the spindle 41.

In other words, the three electrical components, the terminal stand 48, the controller 46, and the capacitor 47 are arranged at right angles to each other around the axis of the spindle 41. Further, in the combination of the controller 46, the capacitor 47, and the speed change controller 49 (the switch 50), and in the combination of the capacitor 47, the speed change controller 49 (the switch 50), and the terminal stand 48, and further, in the combination of the speed change controller 49 (the switch 50), the terminal stand 48, and the controller 46, the three electrical components are arranged at right angles to each other to each other around the axis of the spindle 41.

Further, in other words, the two electrical components, the controller 46 and the speed change controller 49 (the switch 50) are arranged so as to be symmetrical at 180 degrees to each other around the axis of the spindle 41. Further, the two electrical components, the capacitor 47 and the terminal stand 48 are arranged so as to be symmetrical at 180 degrees to each other around the axis of the spindle 41.

As shown in FIG. 4, in order to supply electrical power to the drive motor 40, the tool main body 15 is provided with a power cord 571 that is pulled out from the tool main body 15 to the outsider thereof and connected to an external power source. When pulling this power cord 571 out of the tool main body 15 to the outside thereof, the power cord 571 is guided by a cord guide 572. This cord guide 572 is formed in a substantially cylindrical configuration so as to cover the power cord 571 that is pulled out from the tool main body 15. In order to guide the power cord 571 properly, this cord guide 572 is formed by molding a harder resin than the power cord 571. The member 573 in FIG. 4 is a clamp for clamping the power cord 571 inside the tool main body 15. This clamp member 573 prevents the power cord 571 from detaching from the tool main body 15 even when the power cord 571 is forced to pull out.

The location from which the power cord 571 is pulled out corresponds to the location from which the cord guide 572 is pulled out. That is, the location from which the cord guide 572 (the power cord 571) pulled out is set to be in the direction toward the workpiece facing side 15A with respect to the upper end of the spindle 41. Further, the direction from which the power cord 571, which is guided by the cord guide 572, is pulled out is orthogonal to the direction in which the spindle 41 of the drive motor 40 extends. That is, the direction from which the power cord 571 is pulled out corresponds to a backward direction as seen in the drawing. Further, in the case where the tool main body 15 is put upside down, the direction from which the power cord 571 is pulled out extends in the same direction as the surface direction of the placing portion 38.

The electric power tool 10 described above provides the following effects.

In the above-described electric power tool 10, the controller 46, the capacitor 47, the terminal stand 48, the speed change controller 49, and the switch 50 are arranged at positions offset from the axis of the spindle 41 so that they may not overlap the spindle 41 as seen in a direction corresponding to the direction in which the spindle 41 of the drive motor 40 axially extends, and thus, when air is passed through in the axial direction of the spindle 41, there is no possibility that the airflow is blocked by these components. As a result, the airflow caused by the air blower fan 53 can pass straight within the tool main body 15 with less resistance, and a cooling efficiency can be improved. Further, there is no need to enlarge the volume of the head 15B of the tool main body 15 in order to obtain the airflow passage, and the arrangement of the components inside the head 15B of the tool main body 15 can be more compact and also the height of the head 15B of the tool main body 15 can be lowered. Thus, in the electric power tool 10 configured to perform machining such as edging or grooving the workpiece W such as wood, it is possible to make the arrangement of the components inside the head 15B of the tool main body 15 more compact, to lower the height of the head 15B of the tool main body 15, and to improve the cooling efficiency with the airflow caused by the air blower fan 53 maintained.

Further, in the electric power tool 10 described above, the controller 46, the capacitor 47, the terminal stand 48, the speed change controller 49, and the switch 50 are located so as to overlap at least a part of the drive motor 40 as seen in a direction orthogonal to the direction in which the spindle 41 of the drive motor 40 axially extends, and thus it is possible to overlap a protrusion part of the drive motor 40 and a protrusion part of the controller 46 in the direction in which the spindle 41 axially extends. As a result, it is possible that the protrusion part of the controller 46 and the predetermined protrusion part of the drive motor 40 can be overlapped in the direction in which the spindle 41 extends axially, whereby the head 15B of the tool main body 15 is reduced in bulk and a more compact design can be achieved.

Further, in the electric power tool 10 described above, the controller 46, the capacitor 47, the terminal stand 48, the speed change controller 49, and the switch 50 are located so as to overlap at least a part of the field 42 as seen in a direction coinciding with the direction in which the spindle 41 of the drive motor 40 axially extends, and it is possible to overlap the protrusion part of the field 42 and the protrusion part of the controller 46 in the rotational radial direction of the spindle 41. As a result, it is possible that the protrusion part of the controller 46 and the predetermined protrusion part of the field 42 can be overlapped in the radial direction of the spindle 41 in rotation, whereby the head 15B of the tool main body 15 is reduced in bulk and a more compact design can be achieved.

Further, in the electric power tool 10 described above, the controller 46 is arranged such that the surface of the most extensive plane of the configuration of the controller 46 extends in the direction in which the spindle 41 of the drive motor 40 extends, and it is possible to overlap the spindle and the protrusion part of the most extensive plane of the configuration of the controller 46, in the length direction of the spindle 41 extending in the tool main body 15. As a result, it is possible to efficiently arrange the protrusion part of the most extensive plane of the controller 46 with respect to the spindle 41, whereby the head 15B of the tool main body 15 is reduced in bulk and a more compact design can be achieved.

Further, in the electric power tool 10 described above, two electrical components, for example, the controller 46 and the speed change controller 49 (the switch 50) are arranged so as to be symmetrical at 180 degrees to each other around the position where the spindle 41 of the drive motor 40 extends, and thus, the arrangement space for the two electrical components can be obtained easily and efficiently with respect to the spindle 41. Further, in the above-described electric power tool 10, three electrical components, for example, the terminal stand 48, the controller 46, and the capacitor 47, are arranged at right angles to each other around the axis of the spindle 41, and thus, the arrangement space for the three electrical components can be obtained easily and efficiently with respect to the spindle 41. Further, in the above-described electric power tool 10, four electrical components, for example, the controller 46, the capacitor 47, the terminal stand 48, and the speed change controller 49 (the switch 50), are arranged at right angles to each other around the axis of the spindle 41, and thus, the arrangement space for the four electrical components can be obtained easily and efficiently with respect to the spindle 41.

As a result, the protrusions of the controller 46, the capacitor 47, the terminal stand 48, and the speed change controller 49 (the switch 50) can be efficiently obtained in an obtained arrangement space, whereby the head 15B of the tool main body 15 is reduced in bulk, and a more compact design can be achieved.

Further, in the electric power tool 10 described above, the location from which the power cord 571 is pulled out is located on the head side of the tool main body, and also in the workpiece facing side 15A of the tool main body 15 with respect to the end portion of the drive motor that faces toward the head side of the tool main body, and thus the position of the power cord 571 can be located on the workpiece facing side 15A of the end portion of the head side 15B of the tool main body 15 in which the drive motor 40 is accommodated. The end portion of the head side 15B of the tool main body is the end portion of the head 15B that faces the opposite side of the workpiece facing side 15A of the tool main body 15. Further, the direction from which the power cord 571 is pulled out is orthogonal to the direction in which the spindle 41 of the drive motor 40 axially extends, and thus, there is no possibility that the direction from which the power cord 571 is pulled out does not correspond to the direction toward the end portion of the head 15B of the tool main body.

As a result, in the electric power tool 10 described above, the end portion of the head 15B of the tool main body 15 is formed as the placing portion 38 that allows the tool 10 to put upside down, and thus, in the case where the tool main body is put upside down, there is no possibility that the power cord 571 is caught between the placing portion 38 and the workpiece W. Accordingly, even when the tool main body 15 is put upside down, it can be placed in a stable manner without the power cord 571 being interfered with the tool main body 15. Thus, the usability of the tool main body 15 can be improved.

The electric power tool according to the above construction may not be limited by the above-described embodiment and various changes may be made without departing from the scope of the invention.

The electric power tool 10 according to the embodiment described above by way of example is a trimmer configured to perform machining such as edging or grooving the workpiece such as wood. However, the electric power tool thus performing machining such as edging and grooving may also be a router.

Further, in the electric power tool 10 according to the above-described embodiment, the electrical components related to the driving of the drive motor 40 are the controller 46, the capacitor 47, the terminal stand 48, the speed change controller 49, and the switch 50. However, the electrical components according to the present invention are not limited to these components. Any electrical components will be applied to the present invention so long as they are related to the driving of the drive motor.

We claim:

1. An electric power tool for edging or grooving a workpiece such as wood, comprising:
a tool main body in which a drive motor for rotating a spindle is accommodated,
wherein a controller for adjusting electric power supplied to the drive motor is arranged on a head side of the tool main body, which is on the opposite side of a workpiece facing side of the tool main body; and
wherein the controller is located so as to vertically overlap at least a portion of the drive motor as seen in a direction orthogonal to the direction in which the spindle of the drive motor extends.

2. The electric power tool according to claim 1, wherein the controller is located to be offset from the axis of the spindle so as not to overlap the spindle as seen in a direction corresponding to the direction in which the spindle of the drive motor extends.

3. The electric power tool according to claim 1, wherein the drive motor is provided with a stator that corresponds to a rotor configured to rotate together with the spindle; and
wherein the controller is located so as to overlap at least a portion of the stator as seen in a direction corresponding to the direction in which the spindle of the drive motor extends.

4. The electric power tool according to claim 1, wherein the controller is arranged such that the surface of the most extensive plane of the configuration thereof extends in the direction in which the spindle of the drive motor extends.

5. The electric power tool according to claim 1, wherein there are provided at least two electrical components including the controller that are related to the driving of the drive motor; and
wherein the two electrical components are located symmetrically at 180 degrees to each other around the axis of the spindle.

6. The electric power tool according to claim 1, wherein there are provided at least three electrical components including the controller that are related to the driving of the drive motor; and
wherein the three electrical components are arranged at right angles to each other around the axis of the spindle.

7. The electric power tool according to claim 1, wherein there are provided at least four electrical components including the controller that are related to the driving of the drive motor; and
wherein the four electrical components are arranged at right angles to each other around the axis of the spindle.

8. The electric power tool according to claim 1, wherein the tool main body is provided with a power cord that is pulled out from the inside of the tool main body to the outside thereof and connected to an external power source in order to supply electric power to the drive motor;
wherein the location from which the power cord is pulled out from the tool main body is located on the head side of the tool main body, and also in the workpiece facing side of the tool main body with respect to the end portion of the drive motor that faces toward the head side of the tool main body; and
wherein the direction from which the power cord is pulled out from the tool main body is orthogonal to the direction in which the spindle of the drive motor extends.

9. The electric power tool according to claim 7, wherein the electric components are selected from a capacitor for smoothening power voltage supplied to the drive motor, a terminal stand for use of supplying power to the drive motor, a speed change controller for controlling a rotational speed of the drive motor, and a switch for turning on and off the electric power tool.
